(19) United States
(12) Patent Application Publication
(10) Pub. No.: US 2010/0130251 A1
(43) Pub. Date: May 27, 2010

(54) METHOD AND APPARATUS FOR DISPLAYING BACKGROUND IMAGE ON PORTABLE TERMINAL USING LOCATION INFORMATION

(75) Inventor: Hyong Yol CHU, Gyeonggi-do (KR)

Correspondence Address: CHA & REITER, LLC, 210 ROUTE 4 EAST STE 103, PARAMUS, NJ, 07652, US

(73) Assignee: SAMSUNG ELECTRONICS CO., LTD., Gyeonggi-Do (KR)

(21) Appl. No.: 12/622,634

(22) Filed: Nov. 20, 2009

(30) Foreign Application Priority Data
Nov. 24, 2008 (KR) 10-2008-0116804

(51) Int. Cl. H04M 1/00

(52) U.S. Cl. 455/556.1; 455/566

(57) ABSTRACT

A method and apparatus for displaying a background image on a portable terminal that is associated with a current location of the portable terminal. The method includes: comparing information regarding a location where the portable terminal is currently located with information about a location stored in data; and displaying the data as the background image if the current location information regarding the portable terminal is consistent with the location information stored in data. The background images can be automatically displayed in the portable terminal using a variety of captured data related to the portable terminal user. The data may also be pre-captured and downloaded to the portable terminal.

### CLAIM OF PRIORITY

This application claims priority from an application entitled “METHOD AND APPARATUS FOR DISPLAYING BACKGROUND IMAGE ON PORTABLE TERMINAL USING LOCATION INFORMATION” filed in the Korean Intellectual Property Office on Nov. 24, 2008 and assigned Serial No. 10-2008-0116804, the contents of which are incorporated herein by reference in its entirety.

### BACKGROUND OF THE INVENTION

1. Field of the Invention

The present invention relates to portable terminals. More particularly, the present invention relates to a method and apparatus that can display a background image on a portable terminal.

2. Description of the Related Art

With the rapid development of technology related to semiconductor integrated circuits and information communication, a variety of portable devices have been developed to accommodate the requirements and desires of an increasing number of portable device users. Examples of portable devices include but are not limited to a mobile communication terminal, a mobile phone, a wired/wireless phone, a portable multimedia player (PMP), a personal digital assistant (PDA), a smart phone, etc. Many users desire and often require the portable devices to provide various functions or they will not purchase the portable device, such functions including the setting a background image.

For example, when using the function of setting a background image, users want to set the background screen of the portable device with a variety of background images. In particular, in order to set the background image on the screen of conventional portable terminals, the user directly selects one image from among the images stored in the terminals, the photographs captured by the users, and the downloaded images. These background images were typically images selected by the user for aesthetic purposes.

However, the conventional method for displaying a background image is disadvantageous in that the user must directly select one of the background images previously stored in the portable terminal. Thus, the user feels inconvenienced both during the initial selection and during a subsequent selection if he/she wishes to change the image. Conventional portable terminals do not provide corresponding functions according to users' various requests.

### SUMMARY OF THE INVENTION

The present invention has been made to provide a method and apparatus that dynamically displays a variety of background images on a portable terminal that are related to a user. In addition, the images are associated with location information regarding the portable terminal.

The present invention further provides a method and apparatus that systematically classifies user information using location information regarding a portable terminal.

In accordance with an exemplary embodiment of the present invention, the present invention provides a method for displaying a background image on a portable terminal, which may include: comparing information regarding a location where the portable terminal is currently located with information (descriptive data) about a location stored in data; and displaying the data as the background image if the current location information regarding the portable terminal is consistent with the location information stored in data.

Preferably, the data includes captured data to which location information is mapped. Here, preferably the information regarding a current location of the portable terminal is calculated when the portable terminal takes photographs. The location information regarding the portable terminal at the time of the image is captured is mapped to the captured data.

Preferably, the captured data is acquired by a camera module installed in the portable terminal and a general camera module can be separate from the portable terminal. Here, the captured data is preferably stored together or in some way linked with information regarding a location where the portable terminal took photographs. The captured data is downloaded from an image content provider server and then stored in the portable terminal.

Preferably, the process of comparing information regarding a current location of the portable terminal with location information stored in data includes determining whether or not the current location information regarding the portable terminal is within a certain distance set by a portable terminal user or a default value.

In accordance with another exemplary embodiment of the present invention, the present invention provides an apparatus for displaying a background image on a portable terminal, which may include: a location information calculating unit for determining information regarding a current location of the portable terminal; a camera module that can capture images; a storage unit for storing captured data or images captured by the camera module and location information regarding the portable terminal at a certain time when the images for the captured data are captured; a comparing unit for comparing the information regarding the current location of the portable terminal with the location information stored in the captured data; a controller for processing the stored captured data as a background image if the information regarding the current location is consistent with the location information stored in the captured data; and a display unit for displaying the background image of the portable terminal according to the location information regarding the portable terminal.

In addition, a method for displaying a background image on a portable terminal, comprising:

comparing information regarding a location where the portable terminal is currently located with stored descriptive data about a location stored in data; and

displaying the descriptive data as the background image if the comparison of the current location information regarding the portable terminal at least partially overlaps with a predetermined range of the location information stored in data.

### BRIEF DESCRIPTION OF THE DRAWINGS

The features and advantages of the present invention will become more apparent from the following detailed description in conjunction with the accompanying drawings, in which:

FIG. 1 is a schematic block diagram illustrating a portable terminal that displays a background image using location information, according to an exemplary embodiment of the present invention;

FIG. 2 is a flow chart describing a method for mapping location information and storing data, according to an exemplary embodiment of the present invention; and

FIG. 3 is a flow chart describing a method for displaying a background image using location information, according to an exemplary embodiment of the present invention.

### DETAILED DESCRIPTION

Hereinafter, exemplary embodiments of the present invention are described in detail with reference to the accompanying drawings. The same reference numbers are used throughout the drawings to refer to the same or similar parts. Detailed descriptions of well-known functions and structures incorporated herein may be omitted to avoid obscuring appreciation of the subject matter of the present invention by a person of ordinary skill in the art.

In an exemplary embodiment of the present invention, although a description of the portable terminal is based on a mobile phone, a person of ordinary skill in the art should understand and appreciate that the present invention is not limited to the exemplary embodiment. It will be appreciated that the portable terminal can be applied to all types information communication devices, multimedia devices, and their applications, such as, a mobile communication terminal, a mobile phone, a wired/wireless phone, a portable multimedia player (PMP), a personal digital assistant (PDA), a smart phone, a portable game player, etc., just to name a few possible devices in which the claimed invention is operable.

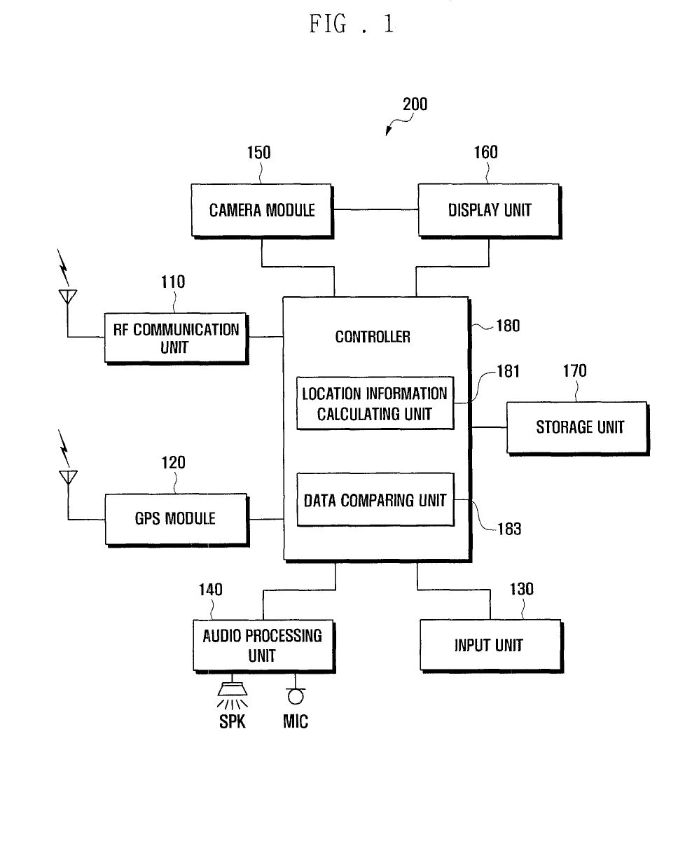

FIG. 1 is a schematic block diagram illustrating a portable terminal that displays a background image using location information, according to an exemplary embodiment of the present invention.

Referring now to FIG. 1, the portable terminal 200 is preferably configured as follows. An RF communication unit 110 communicates with other portable terminals. A GPS module 120 receives location information regarding the location of the portable terminal 200. An input unit 130 receives input signals, generated according to a user's input, and provides them to a controller 180. An audio processing unit 140 processes audio signals generated in the portable terminal 200 or received from outside the terminal. A camera module 150 captures images (i.e. photographs) according to a user's operation and outputs the data corresponding to captured images, which is referred to herein as captured data, to a display unit 160 and the controller 180. The display unit 160 displays images that correspond to the captured data output from the camera module 150 and images that correspond to a variety of image data generated in the portable terminal 200, where the images refer to background images. The display unit 160 can automatically change its background image under control of the controller 180. The display unit 160 can adaptively change the background image to be displayed (or displayed) according to location information regarding a location of the portable terminal 200. A storage unit 170 stores captured data corresponding to images that have been captured by the camera module 150, and information regarding a location where the images were captured. The controller 180 calculates a current location of the portable terminal 200 using location information, acquired by the RF communication unit 110 and/or the GPS module 120, compares information regarding the calculated location with location information mapped to stored data (for example, captured data, documents, images, image data, etc.), extracts captured data related to location information that is consistent with the calculated location information based on the comparison, and controls the operation of the display unit 160. It should be understood that GPS is just one way the location information can be obtained according to the claimed invention.

The controller 180 preferably includes or is in communication with a location information calculating unit 181 for calculating a current location of the portable terminal 200, and a data comparing unit 183 for comparing the location information regarding the portable terminal 200 with location information stored in/with the captured data.

In an exemplary embodiment of the present invention, the portable terminal 200 communicates with a base station and acquires the location information therefrom, via the RF communication unit 110. In such a case, the portable terminal 200 may not include the GPS module 120.

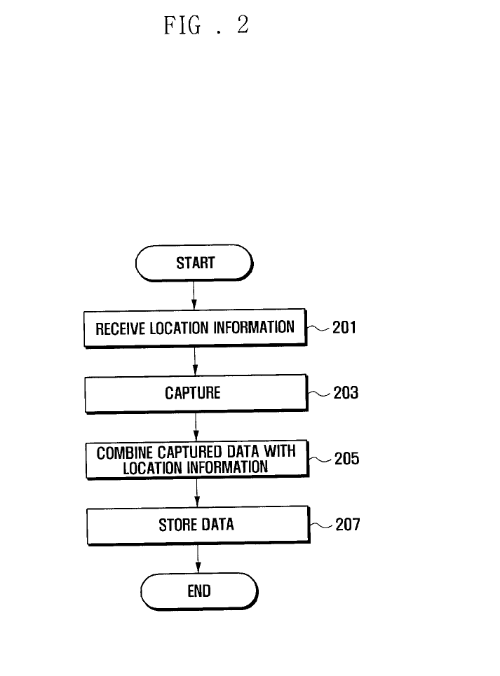

FIG. 2 is a flow chart describing a method for mapping location information and storing data, according to an exemplary embodiment of the present invention.

Referring now to FIG. 2, at step (201) the portable terminal 200 periodically receives location information via the RF communication unit 110 or GPS module 120. The portable terminal 200 detects its own current location, based on the received location information, using the location information calculating unit 181.

Next, at step (203), the portable terminal 200 captures a subject using the camera module 150.

After that, at step (205), the portable terminal 200 combines data corresponding to the captured image with information regarding a location of the portable terminal 200 at the time point that the portable terminal 200 captures the image of subject. Then, at step 207, the portable terminal 200 stores the data related to the captured image in the storage unit 170, where the location information of the present invention is mapped to the data related to the captured image.

In an exemplary embodiment of the present invention, the captured data that will be stored in the storage unit 170 contains location information regarding the portable terminal 200. That is, the portable terminal 200 may map its location information to captured data and then store the captured data in the storage unit 170.

In another exemplary embodiment of the present invention, the location information regarding the portable terminal 200 is mapped to the captured data. It should be, however, understood that the present invention is not limited by the exemplary embodiments shown and described herein. For example, the location information may also be mapped to a variety of data, such as documents, images, image data, etc., just to name a few possible items.

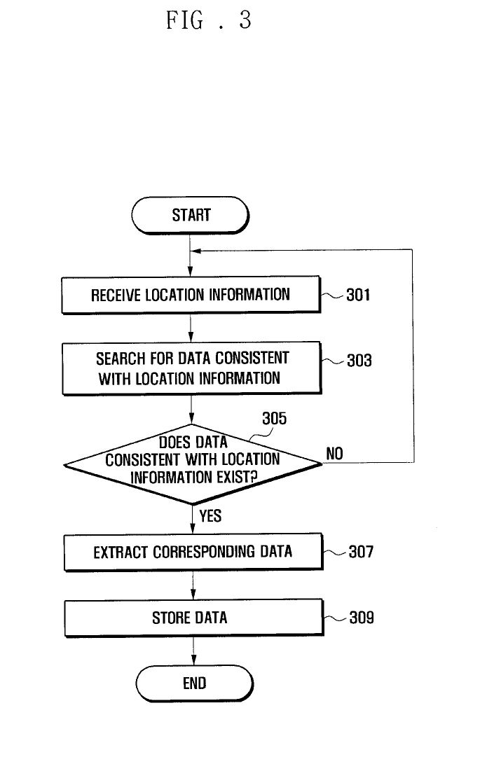

FIG. 3 is a flow chart describing exemplary operation of a method for displaying a background image using location information, according to an exemplary embodiment of the present invention.

Referring now to FIG. 3, at step (301) the portable terminal 200 periodically receives location information via the RF communication unit 110 or GPS module 120. The portable terminal 200 may also update its location information at certain time periods (or intervals) or a particular time (or times) of the day according to a user's settings. In such a case, at step (303) the portable terminal 200 searches for data corresponding to its location information.

Subsequently, at step (305), the data comparing unit 183 determines whether or not data to which location information regarding the portable terminal 200 is mapped, does in fact exists (305). As described herein above, the data may comprise captured data, a variety of image data, documents, and/or images, etc.

Now referring to step 307 and FIG. 3, if the data comparing unit 183 ascertains that data, consistent with location information regarding the portable terminal 200, exists at step (305), then the portable terminal 200 extracts the data at step (307).

Subsequently, at step 309, the portable terminal 200 displays the extracted data on the display unit 210. The extracted data is displayed as a background image by the operation of a corresponding application program.

The data, stored in the portable terminal 200, may be data of images captured by the camera module 150 installed therein or by a general camera separated therefrom. The data may also be data of photographs that are downloaded from an image content provider and then stored in the portable terminal 200. It should also be understood that a link to image data, which could be stored remotely, or a pointer and/or identifier of the captured data, could be used and are within the sprit and scope of the claimed invention. In order to store the data in the storage unit 170 of the portable terminal 200, it can be preferable that a folder is generated to store only data that is associated with location information and displayed on a background image. For example, the data may be stored in a folder where only captured data, to which location information is mapped, is stored.

A determination as to whether or not the location information regarding the portable terminal 200 is consistent with location information in the data is performed by a user's settings or a default value. For example, consistency can refers to a range from a particular location, and a user's setting may be set in such a way that, if a current location falls within the range, so that, for example, if a location of information contained in the data is within a few meters radius with respect to a current location of the portable terminal 200, the data comparing unit 183 concludes that the location information regarding the portable terminal 200 is “consistent” with the location information contained in the data. However, it should be understood that other types of identifiers can be used to determine consistency other than a radius, including but not limited to, for example, longitude, latitude, etc., just to name a few possibilities.

It should be understood that the data that the data comparing unit 183 used to determine location information is not limited to captured data. First, the image does not have to be captured by the portable terminal, but could be provided by, for example, a server. In a further example according to the present invention, the data may comprise a certain document that was used by the user.

As described herein above, the background image can be dynamically displayed by a variety of data related to the portable terminal user, associated with the current location of the portable terminal user. For example, if the current location within an area that includes Yankee Stadium, one can have an image of the Stadium, or a Yankee cap, or their favorite player, or even an opposing team, be displayed in the background.

As described herein above, the method and apparatus, according to the present invention, can allow a user to display a variety of background images that he/she wishes to be displayed on the portable terminal, using a photograph captured by him/her (or possibly downloaded by him/her) or a document used by him/her. The method and apparatus according to the present invention, can also allow a portable terminal user to recall a place that he/she visited, so that the portable terminal can serve as a mobile memory source.

Although exemplary embodiments of the present invention have been described in detail hereinabove, it should be understood that many variations and modifications of the basic inventive concept herein described, which may be apparent to those skilled in the art, will still fall within the spirit and scope of the exemplary embodiments of the present invention as defined in the appended claims.

What is claimed is:

1. A method for displaying a background image on a portable terminal, comprising:
comparing information regarding a location where the portable terminal is currently located with stored descriptive data of about a location stored in data; and
displaying an image associated with the descriptive data as the background image if the comparison of the current location information regarding the portable terminal falls within a predetermined range of the location stored in the descriptive data.

2. The method of claim 1, wherein the descriptive data includes:
captured image data to which location information is mapped.

3. The method of claim 2, wherein:
information regarding a current location of the portable terminal is calculated when the portable terminal is taking photographs; and
the location information regarding the portable terminal is mapped to the captured image data of the photographs.

4. The method of claim 2, wherein the captured image data is acquired by at least one of a camera module coupled with the portable terminal and a general camera module separated from the portable terminal and in communication with the portable terminal.

5. The method of claim 2, wherein the descriptive data is downloaded from an image content provider server.

6. The method of claim 5, wherein the descriptive data includes associated location information that is stored for subsequent comparison with a current location of the portable terminal.

7. The method of claim 1, wherein comparing information regarding a location where the portable terminal is currently located with information about a location stored in data comprises determining whether the current location information regarding the portable terminal is within a certain predetermined distance of the range set by a portable terminal user.

8. The method of claim 1, wherein comparing information regarding a location where the portable terminal is currently located with information about a location stored in data comprises determining whether the current location information regarding the portable terminal is within a certain predetermined distance of the range initially set as a default of the portable terminal.

9. An apparatus for displaying a background image on a portable terminal, comprising:
a location information calculating unit for determining information regarding a current location of the portable terminal;
a camera module for capturing images;
a storage unit for storing captured data or images captured by the camera module and location information comprising descriptive data regarding the portable terminal at a certain time when the images for the captured data are captured;
a comparing unit for comparing the information regarding the current location of the portable terminal with a location information in the descriptive data that is stored in the captured data or linked to the captured data;
a controller for processing the stored captured data as a background image if the information regarding the current location matches or falls within a predetermined range of the location information stored in the descriptive data; and
a display unit for displaying the background image of the portable terminal according to the location information regarding the portable terminal.

10. The apparatus of claim 9, wherein the stored captured data is downloaded from an image content provider server.

11. The apparatus according to claim 10, wherein the stored captured data downloaded from the image server includes location information associated with the captured data.

12. The apparatus of claim 9, wherein the data comparing unit determines whether a current location of the portable terminal and a location stored in the stored captured data are within a certain radius set according to a user's settings.

13. The apparatus of claim 9, wherein the data comparing unit determines whether a current location of the portable terminal and a location stored in the stored captured data are within a certain radius set according to a default setting in the portable terminal.

14. The apparatus of claim 9, wherein the stored captured data includes captured data that is generated from images captured by an attachable camera separated from the portable terminal when the images were captured and attached to the portable for storage of the captured data in the portable terminal.
